(19) United States
(12) Patent Application Publication
(10) Pub. No.: US 2017/0178200 A1
(43) Pub. Date: Jun. 22, 2017

(54) Application for Efficient Online Advertising

(71) Applicant: Loïc Asin, Lyon (FR)

(72) Inventor: Loïc Asin, Lyon (FR)

(21) Appl. No.: 15/387,746

(22) Filed: Dec. 22, 2016

Related U.S. Application Data
(60) Provisional application No. 62/271,028, filed on Dec. 22, 2015.
(60) Provisional application No. 62/311,483, filed on Mar. 22, 2016.

(51) Int. Cl. G06Q 30/02; G06F 17/30

(52) U.S. Cl. CPC G06Q 30/0271; G06Q 30/0277; G06Q 30/0267; G06F 17/30312; G06Q 50/01

(57) ABSTRACT

A method and system for people to enjoy a great digital experience, to show their support to an entity they support, to make their favorite “entity” win the contest, to buzz online as well as from the entity to improve its advertisement and commercial performance based on prized competitions. A mobile device application that allows users to participate creation contests in order to gain recognition on social media networks. A method that enables advertisers to host prize competitions that attract and motivate users to create and design a great ad for the entity with their logo/motto and/or trademark on the medium. A user is capable of creating his own medium during an event, submit the medium for validation to a third-party commercial network company, which acts as the hosting platform, and share the created medium on social media networks.

### CROSS REFERENCE TO RELATED APPLICATION

This application takes priority from and claims the benefit of U.S. Provisional Patent Application 62/271,028 filed on Dec. 22, 2015 and U.S. Provisional Patent Application 62/311,483 filed on Mar. 22, 2016, the contents of which are herein incorporated by reference.

### BACKGROUND OF THE INVENTION

Field of the Invention

The subject invention relates generally to an online social application platform, and more particularly to an online social application platform for users to illustrate themselves during events, to show their support for a team/band/city/movie/series/product/brand/cause or any other “group” competing with another one, and to make the latest “group” win a contest organized by the application as well as to personally win the contest as a user within the group chosen. The subject invention also aims at creating customizable online advertisement by a (potential) customer.

Description of the Related Art

Traditional online advertising has boomed during the last decade and it is still is a very efficient way for companies to advertise. Procter & Gamble Co., the nation's and world's largest advertiser, is among those making the pitch to Wall Street that digital is more efficient.

Companies traditionally advertise on platforms that experience heavy traffic. For example, companies advertise on frequently viewed websites through banner-like mechanisms, on popular social media networks like Facebook, and through popup advertisements, etc.

Typically, professionals create commercial ads in advertising companies and are displayed through traditional channels like posters and billboards. Currently, platforms such as eYeka® and Creads® allow freelance professionals to create ads for companies following detailed instructions. These platforms accept submissions from multiple freelance professional artists and then send the ads created to the company who then will choose the ad they like best and use it for its advertising campaigns. The freelance professional whose ad is chosen receives money and is motivated to continue to submit ads to companies. Typically, freelance professionals work for free creating these ads and only get paid if their work is selected.

However, the general society does not appreciate the constant advertisement. Even though people may enjoy surfing on a free Internet, they are getting more and more fed up by the present kind of advertising. Ad blocking software, such as AdBlock®, is growing in popularity and allows for consumers to block ads that may appear during the time they web surf. Further, ad blocking software has evolved to not only block advertisements on computer based Internet advertisements but also mobile phone Internet advertisements. For example, the latest Apple® iOS update for the iPhone allows people to block ads that may be distributed on their mobile device. In August 2015, Adobe® conducted a poll that forecasted a drop of more than G$40 in traditional advertising in the year 2016 because of ad blocking software.

Neuroscientists have proven that emotions are responsible for a consumer's ability to memorize and recall ads. An ad that excites no emotions does not activate the hypothalamus—the zone responsible for memorization in our brains—whereas an ad that coveys strong emotions to the tester efficiently activates this part of the brain. Sources mainly come from the work of Bernard Roullet and Olivier Droulers, both researchers at the IREA and respectively associated members of the PRISM (the research center of La Sorbonne in Paris, France) and the CREM (Management & Economy Center of Research in Rennes, France).

The advertising world has also noted that people ages 15-34 utilize social media networks in order to flatter their egos. Currently, many individuals seek out to receive a high number of “likes” on Facebook®, “favorites” on Instagram® and/or a high number of “retweets” on Twitter®. The small approvals and gratifications from the online community boost user's egos.

Advertising companies have tried to respond to this trend by developing ways to promote products through online advertising. However, with the development of online advertising comes the development of ad blocking software being heavily used to avoid viewing unwanted ads. Therefore, many ads are blocked before even viewed.

To solve the problem of advertising companies unable to offer efficient and effective online advertising because of online advertising not triggering emotions and thus utilizing ad blocking software, the instant development sets forth a system that provides a mode of online advertising that offers powerful, emotionally driven ads that allow people to utilize the same gratification received from social media and boost their ego while still promoting a particular entity during popular events. Promoting events, brands, products, causes, teams, cities, movies, series, etc. also implies new functionalities and concepts that will be listed afterwards.

### SUMMARY OF THE INVENTION

The instant invention, as illustrated herein, is clearly not anticipated, rendered obvious, or even present in any of the prior art mechanisms, either alone or in any combination thereof. Therefore, it is an object of the instant invention to provide a mobile device application allowing users to illustrate the way they live an event and/or to illustrate the way they support a team, a group, a singer, a city, a school or whatsoever through contests; this creation from a user being at the same time an ad for a company working with a third-party commercial network company (such as Krowdis). There are actually contests within the contest:

A group contest—for example, between two hockey fan teams, between two products from the same company, between two distinct companies or between ten cities in which a band plays for instance—the winning team being known as “live” and being calculated through the app and thanks to a simple algorithm that takes into account the size of the fan team, the number of medium posted, the number of views and the number of “awards” (name of a “like” on Krowdis) received. It may be displayed in percentages, through charts, a total of points or in any other way.

A personal contest: between all the fans of a same team, the goal being to get as many “awards” for a user to personally win the contest and to win the “big award”. Gifts (or amounts of money) will generally be won by users that buzz the most. Sometimes there will be only one winner, sometimes three, sometimes ten etc. depending on the rules of the contest. Gifts sometimes can be won by randomly selected users, or by users selected by the Krowdis team (or another group of people) on different criteria.

Sometimes, users have goals to reach. For instance, if they get 30 awards they win $5, 100 awards $20 etc. (The ratio between number of awards and amount won can change and is just given for a better comprehension). It can be in cash or the equivalent (or more) in presents.

Sometimes, users can make the buzz and win prizes/cash that will be given to charities/associations.

Gifts and how gifts are won are always indicated in the rules of each contest.

Most of the time, users get points when they publish and get awards. Those points are accumulated in their account and they can convert them into gifts, sometimes cash etc.

In several embodiments, the medium for creating an ad may include a picture, a video, a playback video, a drawing, or a sound. In further embodiments, the mobile device application may offer different functionalities for the user's chosen medium such as filters, frames, and sounds. The logo, motto, and/or trademark of the entity the user chooses to support would appear on every medium a user chooses to publish. The logo, motto, and/or trademark of the entity's sponsor may also appear on every medium published if the entity at stake chooses to make its sponsor pay for this campaign.

The logo, motto and/or trademark might be added to the original picture the user took—the user placing them where he wants on the picture, and adjusting their sizes. Sometimes, the customization of the picture into an ad might be imposed to the user—modification of the picture into an ad is done automatically. Sometimes the customization might be done in a different way (see explanation in the drawings) and sometimes other mediums than picture can be asked during a contest (video, playback video, sounds, drawings etc.). This is also details in the drawings section.

It is a further object of the instant system to provide a mobile device application wherein a user chooses a medium, has (sometimes) it validated through a third party, and proceeds to share it on social networks including, but not limited to Facebook®, Instagram®, Twitter®, Google+®, etc. A user can also send his created medium through email to friends and family.

It is a further object of the instant system to provide a mobile device application wherein a user is awarded for the created medium which is also a commercial for the entity (and for its sponsor) as their logo, motto, and/or trademarks, or at least something linked to the entity will be on the medium. Sometimes the application will allow the user to recreate an existing ad. Instead of a famous individual like an athlete, or movie star or someone the user does not know, the user himself will be on the ad. After a user shares his created medium with others through social media networks, he may be awarded and recognized as a winner of the contest. Similar to a Facebook® “like” option, an award is received when other third-party users acknowledge and recognize the commercial on the commercial network company. The number of acknowledgements or awards a user receives for his creation generally determines a winner of the contest. Users may see their submitted medium they created on posters and billboards throughout their city. Sometimes, a new picture with a professional team may be realized.

It is another object of the current system to provide a mobile device application for users to both promote entities/sponsors while gaining recognition on social media networks and showing one's passion about something (in the case of a contest for a sports team sponsored by a company for instance).

It is yet another object of the instant system to provide a mobile device application that allows users the possibility to create an ad for a company, share the created ad on personal social media networks in order to boost the number of views and “likes” to their profiles thus further flattering a user's ego.

It is an object of the instant system to provide a mobile device application that allows for customizable advertisements.

Furthermore, it is an object of the instant system to provide a mobile device application to allow people to create ads for things they like and share them with people they know, thus avoiding the ad being blocked by AdBlock software or SPAM filters.

It is yet another object of the instant system to provide a mobile device application that allows advertising to be personalized and efficient. A company may reach more people faster by partaking in the contests. An ad that is personalized, where is displayed something from the entity that sponsors the contest and that is shared with the public receives more acknowledgement based on the number of users who choose to participate in the contest and who share it with all of their contacts freely, avoiding AdBlock software.

It is yet another object of the instant system to revolutionize advertising by understanding what people want when posting on social media networks (to flatter and boost their ego), by understanding how ads are efficient (emotions are responsible for the memorization of ads and stories prevails over products), by understanding that digital advertising is the future of advertising, and by linking those three main points in the development of the mobile device application.

It is also another object of the instant system to provide a website to provide a platform to allow people to vote for their favorite customized ad and to higher the number of views (important for those who do not have the app).

Currently, no known alternative solutions exist for efficient customizable advertising. There has thus been outlined, rather broadly, the more important features of a customizable online advertisement platform in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the system in detail, it is to be understood that the system is not limited in its application to the details set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a schematic diagram of an exemplary embodiment of a computer system;

FIG. 2 is a schematic diagram of an embodiment of a system used for customizable advertising;

FIG. 3 illustrates one embodiment of a mobile device application notification option when a new event contest starts;

FIGS. 4A-4Q illustrate several embodiments of a mobile device application match (or contest) tab option and also illustrates how a user of the mobile device application participates;

FIGS. 5A and 5B illustrate another embodiment of a mobile device application profile tab option; and,

FIG. 6 illustrates one embodiment of the mobile device application notification tab.

### DETAILED DESCRIPTION OF THE SEVERAL EMBODIMENTS

For the following defined terms, these definitions shall be applied, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed invention.

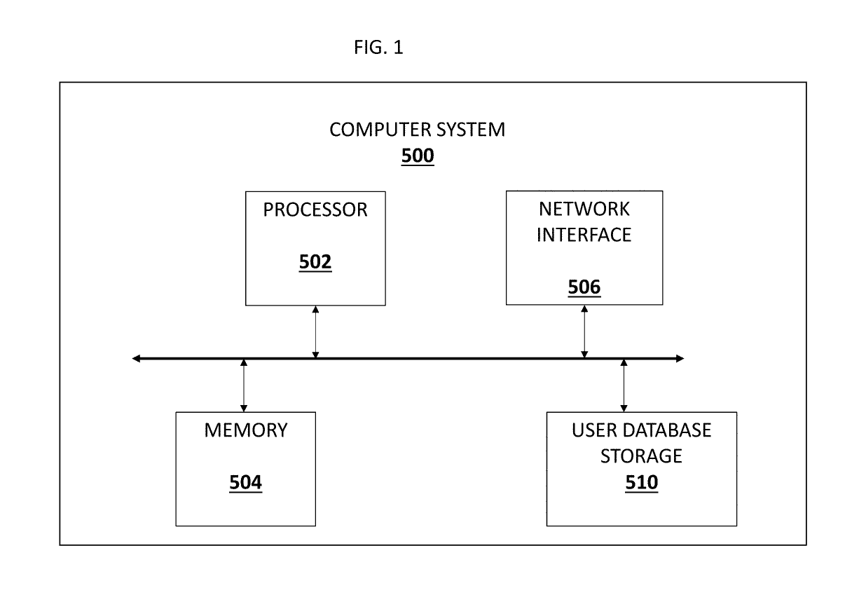

FIG. 1 is a schematic diagram of one exemplary embodiment of a computer system. Herein, the systems and methods disclosed may be implemented using one or more computer systems, such as the exemplary embodiment of a computer system 500 shown in FIG. 1. As shown, the computer system 500 can include one or more processors 502 which can control the operation of the computer system 500. The processor(s) 502 can include any type of microprocessor or central processing unit (CPU), including programmable general-purpose or special-purpose microprocessors and/or any one of a variety of proprietary or commercially available single or multi-processor systems.

The computer system 500 can also include one or more memory device(s) 504, which can provide temporary storage for code to be executed by the processor(s) 502 or for data acquired from one or more users, storage devices, and/or databases. The memory device(s) 504 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies. The various elements of the computer system 500 can be coupled to a bus system. The bus system may be any one or more separate physical busses, communication lines/interfaces, and/or multi-drop or point-to-point connections, connected by appropriate bridges, adapters, and/or controllers. The computer system 500 can also include one or more network interface(s) 506, one or more input/output (IO) interface(s) 508, and one or more storage device(s) 510.

The network interface(s) 506 may be configured to enable the computer system 500 to communicate with remote devices (e.g., other computer systems) over a network, and can be, for example, remote desktop connection interfaces, Ethernet adapters, and/or other local area network (LAN) adapters.

The IO interface(s) 508 can include one or more interface components to connect the computer system 500 with other electronic equipment. For example, the IO interface(s) 508 can include high speed data ports, such as USB ports, 1394 ports, etc. Additionally, the computer system 500 can be accessible to a user, and thus the IO interface(s) 508 can include displays, speakers, keyboards, pointing devices, and/or various other video, audio, or alphanumeric interfaces. The storage device(s) 510 can include any conventional medium for storing data in a non-volatile and/or non-transient manner.

The storage device(s) 510 can thus hold data and/or instructions in a persistent state (i.e., the value is retained despite interruption of power to the computer system 500). The storage device(s) 510 can include one or more hard disk drives, flash drives, USB drives, optical drives, various media cards, and/or any combination thereof and can be directly connected to the computer system 500 or remotely connected thereto, such as over a network. The elements illustrated in FIG. 1a can be some or all of the elements of a single physical machine.

In addition, not all of the illustrated elements need to be located on or in the same physical or logical machine. Rather, the illustrated elements can be distributed in nature, e.g., using a server farm or cloud-based technology. Exemplary computer systems include conventional desktop computers, workstations, minicomputers, laptop computers, tablet computers, PDAs, mobile phones, and the like. Although an exemplary computer system is depicted and described herein, it will be appreciated that this is for sake of generality and convenience. In other embodiments, the computer system may differ in architecture and operation from that shown and described here.

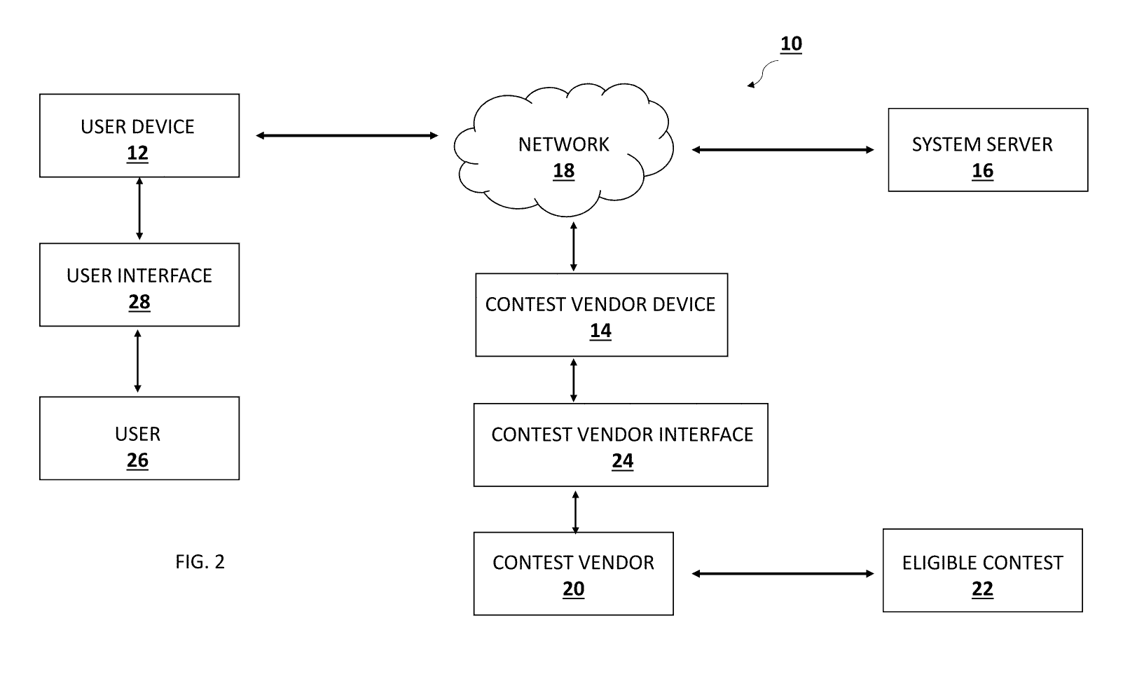

FIG. 2 is a schematic diagram of one embodiment of a system used for customizable advertising, as discussed, user-friendly personal advertising to promote a product, event, venue, trademark, etc. FIG. 2 illustrates an example of an embodiment of a system for providing a mobile device application that allows for customizable advertisements (system 10).

As shown in FIG. 2, the system 10 includes: one or more user devices 12, one or more contest vendor devices 14, and a system server 16. As shown, the user devices 12 and contest vendor devices 14 communicate with the system server through one or more communications networks 18. As described further herein, one or more contest vendors 20 may provide information regarding an available contest 22 for which access is to be offered to the system server 16 through their respective contest vendor devices 14 using a contest vendor interface 24.

The system server 16 may use the information communicated through the user devices 12 and the contest vendor devices 14 to provide data regarding real-time, market-based access to an available contest to one or more users 26 through a user interface 28 provided through the user devices 12.

The user device 12 shown in FIG. 2 may be, for example, a mobile electronic device, such as, a smartphone, a tablet computer, a website, etc. Generally speaking, a user device 12 is most typically a handheld device, commonly including a display screen with touch input, a keyboard, and/or additional input devices. The user device 12 includes an operating system and can run various types of application software. The user device 12 may be equipped with cellular communication capabilities, WI-FI, Bluetooth, GPS, etc. capabilities that can allow the user device 12 to connect to the Internet, connect to other Bluetooth capable devices, identify the location of the user device 12, and otherwise communicate with other devices and systems, both near and far.

While it is contemplated that the most commonly implemented user device 12 will be a mobile electronic device, particularly due to the likelihood that a user will have a mobile electronic device on hand at the moment an eligible contest 22 will be made available. Furthermore, due to the import of location based services to various aspects of the system 10, it is understood that the user device 12 may be any electronic device through which the user interface 28 may be provided.

The vendor device 14 shown in FIG. 2 is a computing device through which a contest vendor 20 may access and interact with a contest vendor interface 24 to provide information about a contest 22 for which the contest vendor wishes to offer to users. It is understood that the contest vendor device 14 may be any electronic computing device, whether mobile, handheld, etc.

The eligible contest 22 shown in FIG. 2 may be numerous contest opportunities for which a contest vendor may wish to provide opportunity for a user to participate in customizable advertising. As shown by the various examples provided herein, the request contests may include a commercial for an entity (and for its sponsor), an advertisement for the contest vendor itself, promotion of a product, event, charity, destination, etc.

The system server 16 shown in FIG. 2 may be embodied in one or more system servers 16. The system server 16 may run a variety of application programs, may access and store data, including accessing and storing data in an associated database (which may be embodied in one or more databases) and may enable one or more interactions via various interfaces, including the user interface 28 and the vendor interface 24.

For example, the system server 16 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system server 16 may also include mass storage devices such as various solid-state drives, disk drives, tape drives, etc. In operation, the main memory may store at least portions of instructions for execution by the CPU and data for processing in accord with the executed instructions.

The system server 16 may also include one or more input/output interfaces for communications with one or more processing systems. One or more such interfaces may enable communications via the network 18 to enable sending and receiving instructions electronically.

Those skilled in the art will recognize that the description of the system server 16 also encompasses all kinds of controllers such as host computers, workstations, network terminals, and the like. In fact, the use of the term system server 16 is intended to represent a broad category of components that are well known in the art.

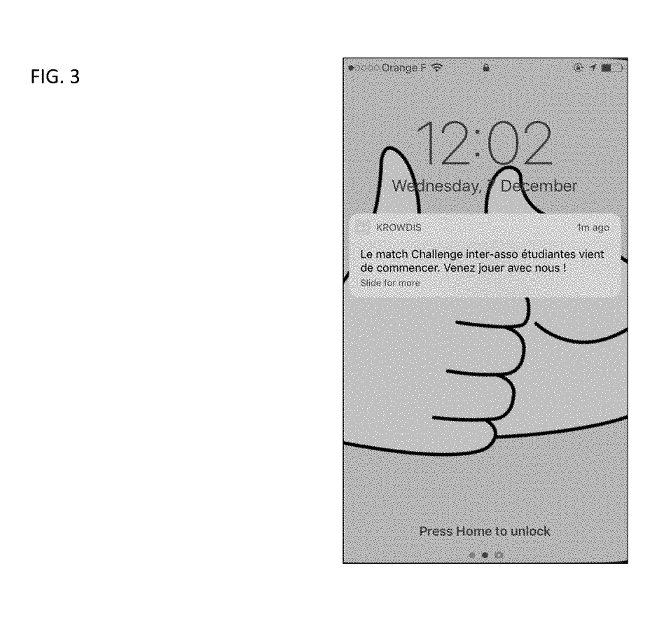

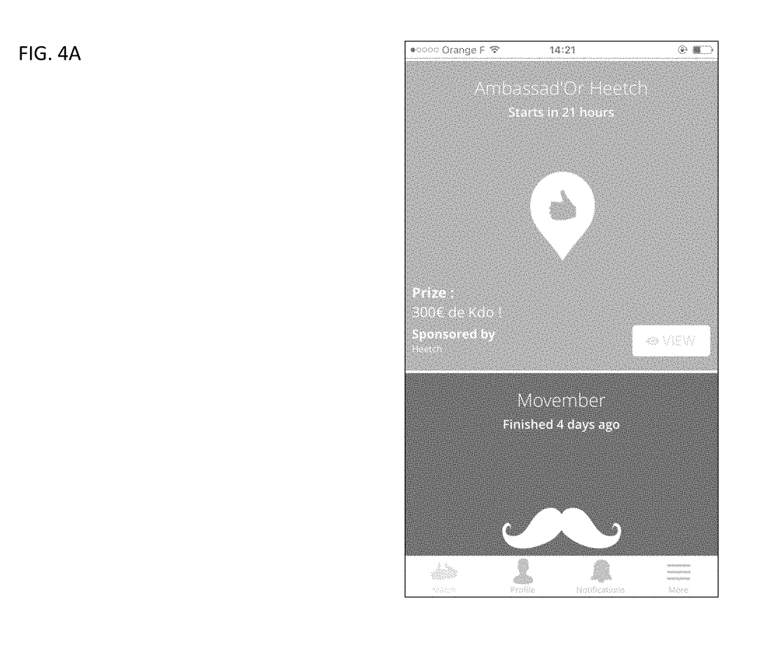

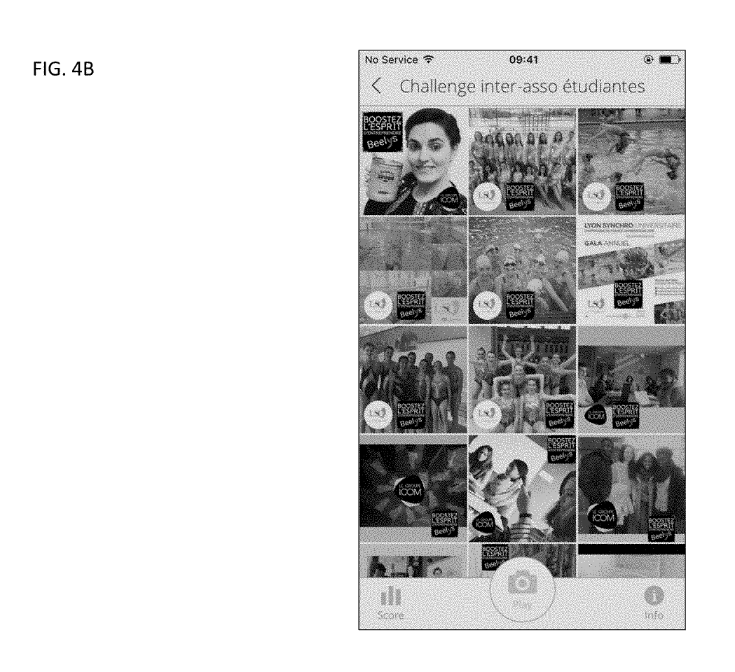

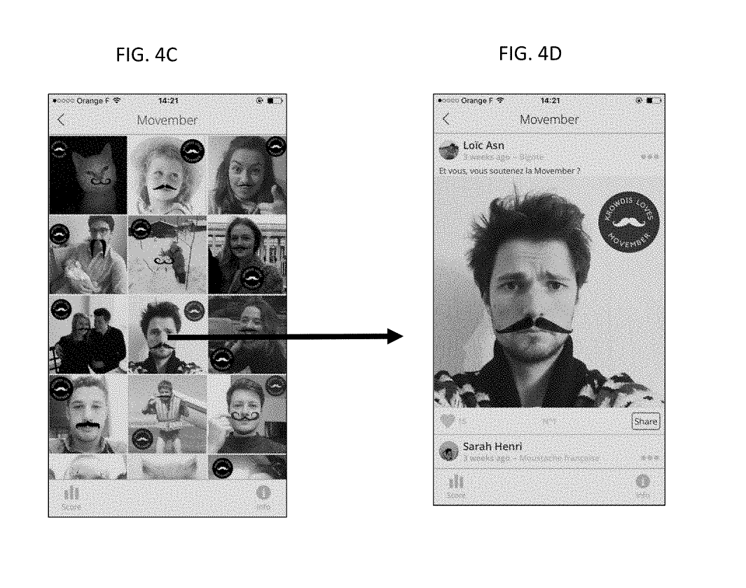

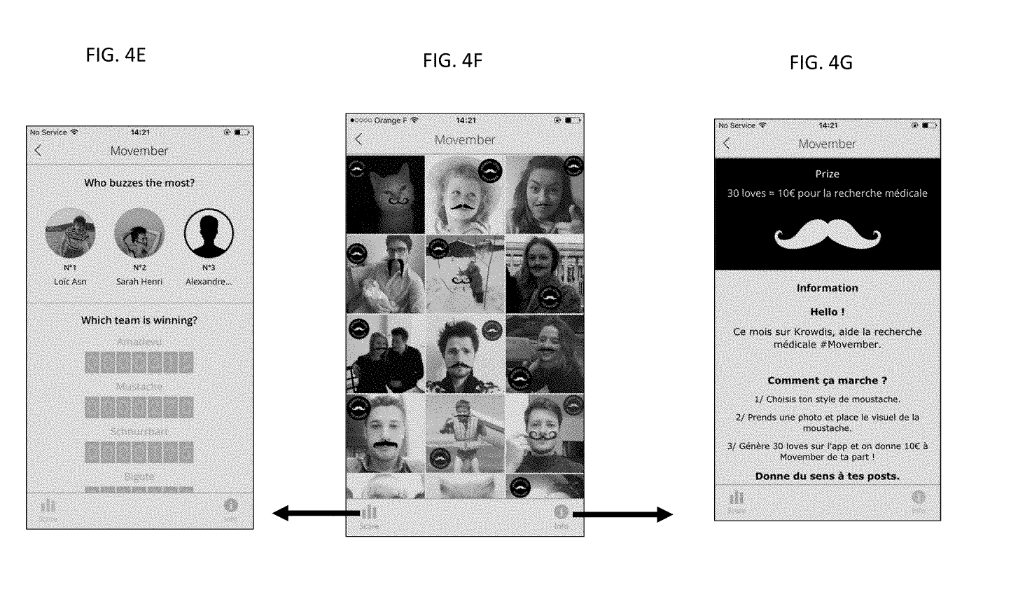

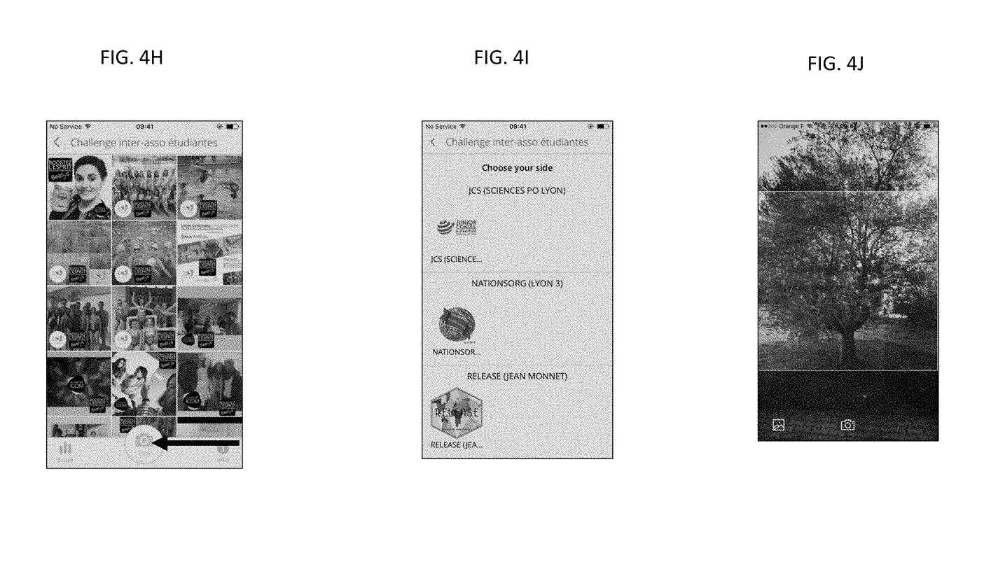

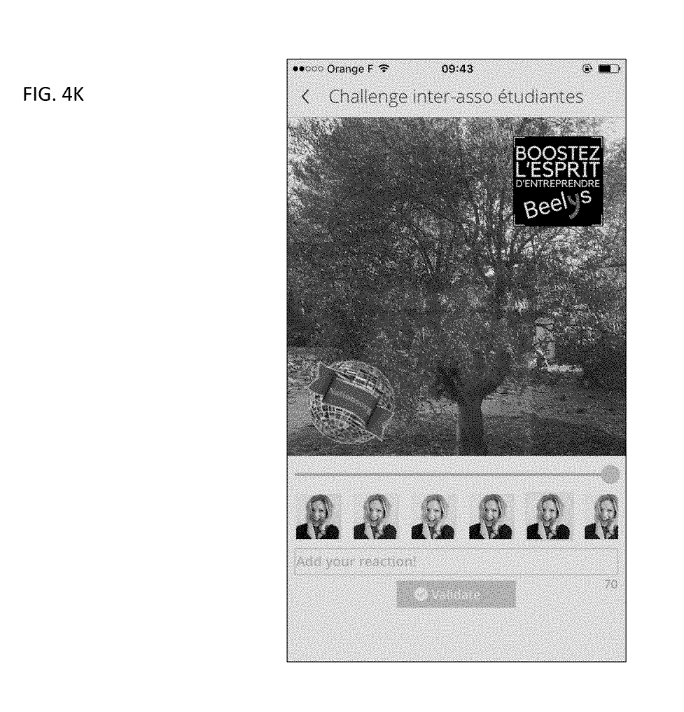

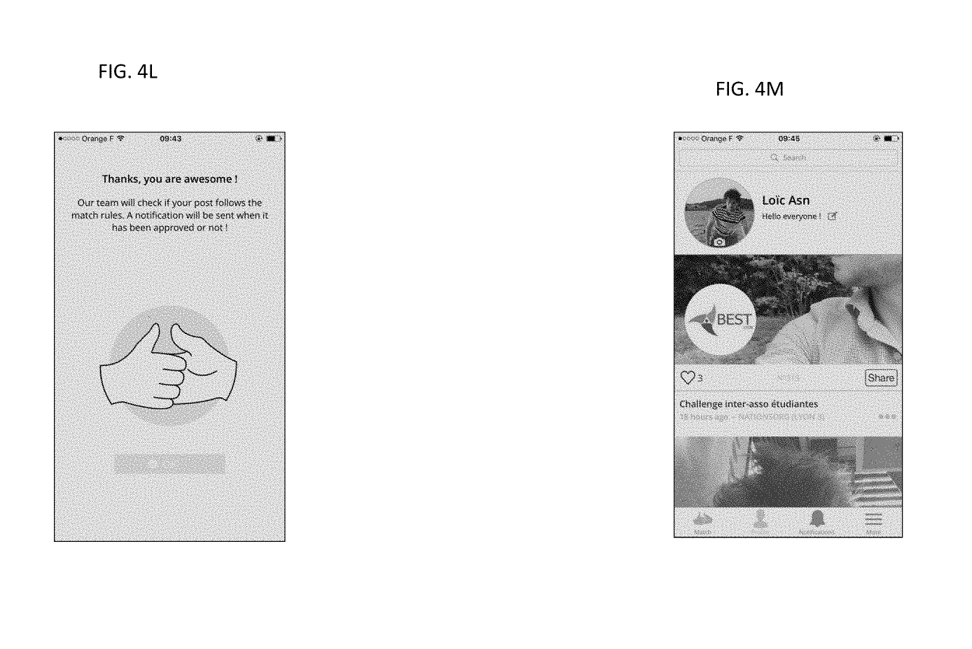

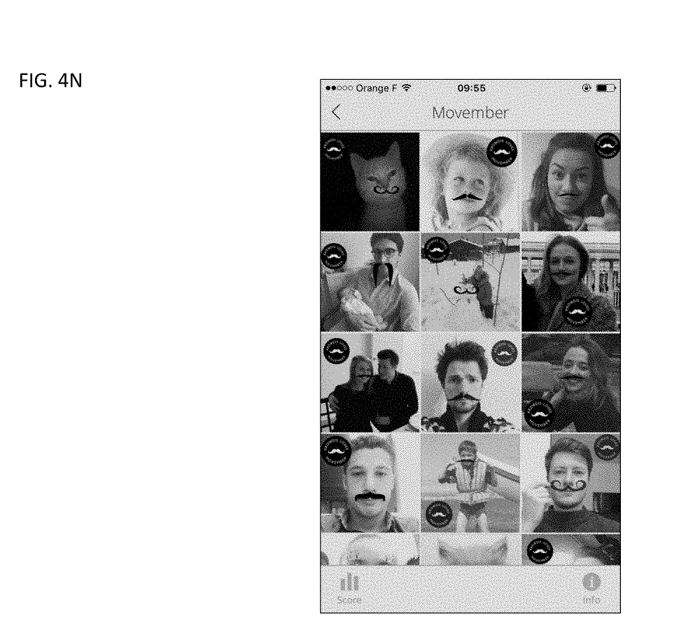

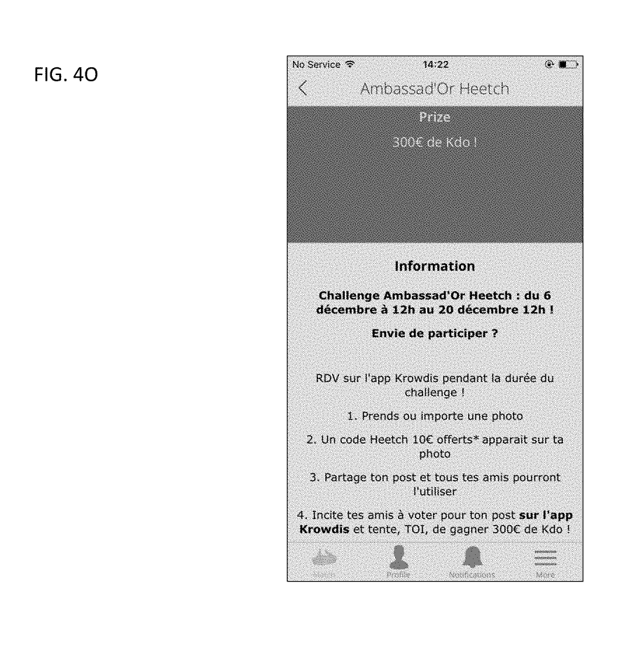

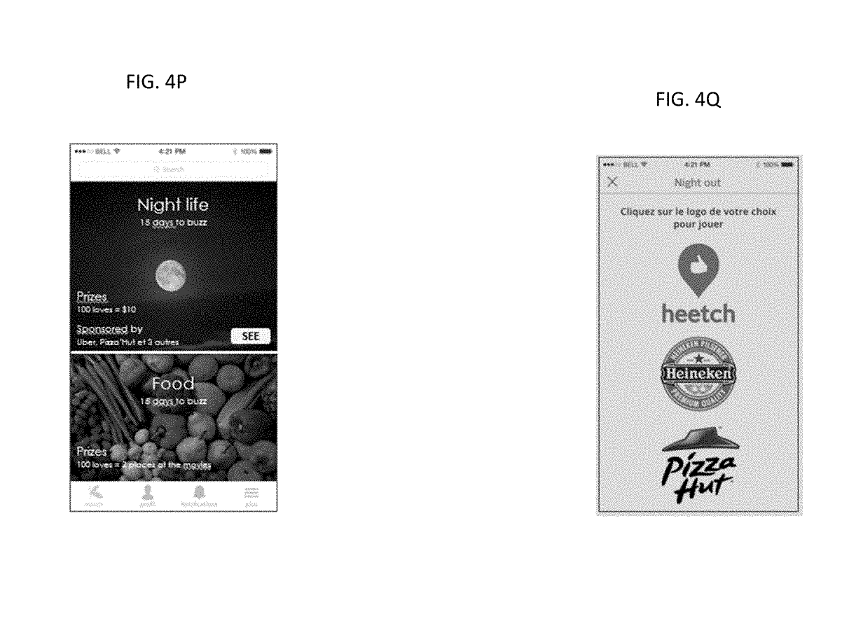

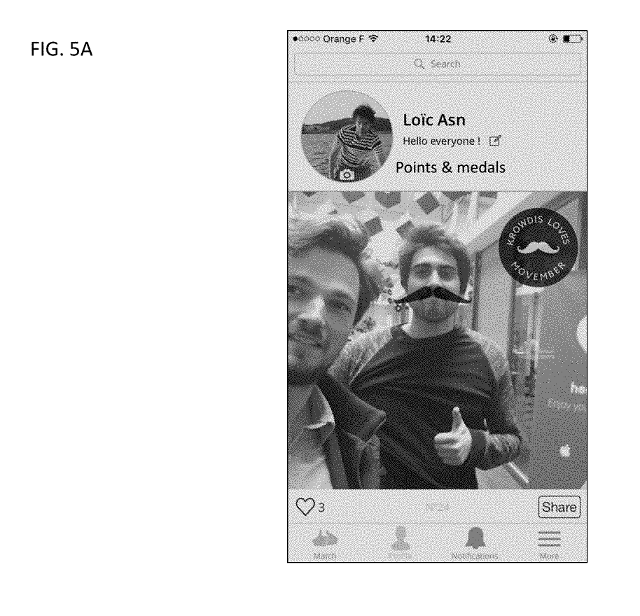

Turning now to FIG. 3, the user interface 28 may be provided in a user device 12 embodied in a mobile electronic device, such as a smartphone. The user interface 28 may include various information and interactive functions through which a user 26 may view a real-time, market-based, contests, and, further, the user may participate in the contest by opting in to the eligible contest. While shown in FIGS. 3, 4A-4J in a single display with each of the elements visible at once, it is contemplated that the display of the elements described may be provided over numerous displays and that not all of the elements may be visible to a user at a single point in time. See FIGS. 3, 4A-4Q for several embodiments portraying different user interfaces that may be utilized.

FIG. 3 illustrates one embodiment of a mobile device application notification interface option when a new event contest starts. In a preferred embodiment, a user is alerted by a notification when a new contest starts. Further, a user is alerted through notifications when the user's created “commercial” is awarded, when the user's created medium is validated by a third-party commercial network company (if medium are validated during this contest) and when the third-party commercial network company wishes to inform a user on a particular topic. FIG. 3 displays an example of a notification a user receives when a new contest starts activated by a third-party commercial network company or a contest vendor.

In this particular embodiment, an application user receives a notification alerting the user of a new contest. In some embodiments, if the contest is local based on the location of the user, the notification may only be sent to users in a particular location. In instances where location does not matter, or the contest vendor wishes to make the contest a global matter, every user will be alerted of the contest specifications.

FIGS. 4A-4Q illustrate illustrate several embodiments of a mobile device application contest tab option and also illustrates how a user of the mobile device application participates. First, FIG. 4A illustrates one embodiment of the tab. In a this embodiment, the page shows ongoing, future, and previous contests. It shows the tittle of the contest, the prizes users can win and the sponsor(s) of the contest.

FIG. 4B illustrates one embodiment of a mobile device application match (or contest) tab option. Publications are posted here. Publications from friends, publications that are rewarded (or loved) the most may be displayed at first to generate content and eventually may be used to allow users to “follow” other users. This feature allows users not only to view popular publications, but also, any publications posted by the individuals the user chooses to follow. In some contests, users might be limited to publish only one medium.

FIGS. 4C-4D allows users to see medium in a larger size. They can discover the name, the number of awards (or “loves”) a user has, they can themselves love some mediums. They also discover the description of the medium the user can put. Allowing users to comment a medium from another user might be implemented. Please note that pictures are taken in example, but it can also be sounds, videos, playback videos, music, drawings and any other creative ways to promote a company, an event, a cause, a team, etc.

In yet another embodiment, companies and brands may write message during conducted contents. In preferred embodiments, different “buttons” represent different options provided to a user. For example, a “love” (reward) option is used to award posted commercials with recognition. Other button options allow a user to post his created commercial to a variety of different social media networks, such as, Facebook®, Google+®, Instagram®, Twitter®, Pintrist®, etc. These options allow for easy sharing of a user's created medium. Users may also easily send their created commercials to other via email, text message etc.

In yet another embodiment, individuals who are not registered to the third-party commercial network company platform may gain access to limited news and be able to view contests through the Krowdis website.

FIGS. 4E-4G illustrates other embodiments of a mobile device application contest tab option. By clicking on “score” user can see who is making the buzz in terms of users and in terms of teams (cumulated points between users that selected the same team). These scores are calculated through a simple algorithm. By clicking on “info” user sees a description of the prizes for this specific contest as well as the most important rules of the contest (full rules available on the website) and tips.

FIG. 4H-4J shows how a user can participate to a contest. The figure shows that a user can participate to a contest by clicking on the “Play” button. FIG. 4E shows that a user needs to choose a team to participate to a contest (this step might be optional during contest with no teams). After clicking on team (or directly if the contest has a single team), user's camera puts on and user can either take a picture or import it from his smartphone. When he likes his pictures, he validates it and the picture transform itself through the app into a “commercial”.

Logos, mottos, trademarks might appear on the picture and user might put and resize them where he wants as illustrated in FIG. 4F. The picture might change itself into a commercial for the contest's sponsor without allowing the user to transform it. Please note that in some cases during steps configured in FIG. 4E the camera opens directly with a frame that directly changes the picture into a commercial.

Pictures have been taken into example to illustrate the process, however and depending on the contest, it could have been a playback video, a video, a song, a sound, a drawing that the user would have to transform into a “personalized commercial”. For instance, he could have been ask to shoot himself on a playback video for an existing commercial, he could have been asked to talk on an existing mute commercial video, he could have been asked a shoot a video transformed into a commercial video (logos, mottos, trademarks, special effects added), he could have been asked to make a sound that illustrates the sponsor's atmosphere according to him, to create and music or a drawing for the sponsor and so on.

The underlying principle being to allow regular people to create “ads” for companies, causes, products, teams or any other entities they want to support. It is efficient for a company as people will see a “commercial” with someone they know on it. It is interesting for users as they can buzz thanks to it, as they win prizes if they make the buzz and reach some objectives given in the contest rules and as they can “give meaning’ to their posts online (by supporting something and not just by publishing things online).

The mobile application puts together the general public and entities; each of them having an interest by participating to a Krowdis contest. The mobile application is a new way to advertise for companies, and a new way to publish things online for people.

FIG. 4K shows the screen displayed to users after they validated their created ad. This screen only appears if medium is validated before being published. Otherwise the message would be a congratulations message for the ad created.

Please note that the app can be customized to the sponsor's colors and atmosphere after a user published for him, during a period of time.

FIG. 4L-4M also shows the “share” button a user can use to share his created “commercial” on his social networks, by email, text message etc.

FIG. 4N shows the screen a user sees when pressing on a finished contest. He can see exactly the same things than for an ongoing contest. However he cannot participate to the contest as it is finished. The “Play” button does not appear.

FIG. 4O shows the screen a user sees when pressing on a future contest. He can only access to the “info” screen displaying the prizes users (or teams) will be able to win as well as rules and tips of the contest.

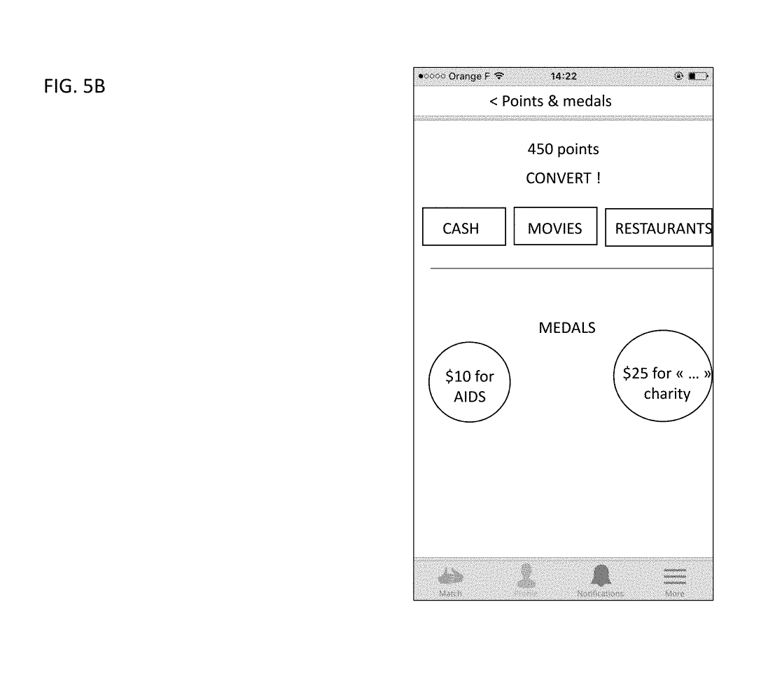

FIG. 4P-4Q explains that the example taken previously was based on contests created especially for some sponsors and generally ongoing during a certain amount of time. However, other kind of contests exists on Krowdis: “theme” contest. Contests that are not created only for one (or several) sponsor(s) but for people to be able to publish at any time. A theme could for instance be “sports”, “food” or “night out”. Users will choose a sponsor they want to be associated to those themes. For instance, they can have the choice to choose Nike, Adidas or Puma in the sport theme contest. Picture transforms itself into a commercial for the company chosen (as shown in FIG. 4J). Users win points and prizes depending on the theme and associated rules (this aspect will be explained more in details in FIG. 5.)

In some embodiments, usually companies pay Krowdis depending on the success of a campaign (number of views, number of likes) and/or depending on the awards won by the users, in addition to a fix entering price.

A website will allow sponsors to create the way they want mediums to be modified, to put more money in a campaign if they want to, to follow the success of their campaign.

FIGS. 5A and 5B illustrate other embodiments of a mobile device application profile tab option. In a preferred embodiment, FIG. 5A shows the profile tab option displays specific information about the user like name, picture, and details about the user. It might later display the “interests” of the user: sports, music, cities, special contests, and so on. The user can change those interests, and depending on what interests he chooses he will receive (or not) notifications for new contests linked to the latest. Further, the profile tab may display publications of a user. The publications may be posted in chronological order and displays a summary of all the contents a user has participated in. The profile may also display the number of awards each submitted created commercial received. Publications are displayed on a user's profile and on the newsfeed tab option after having been checked by and approved by a third-party commercial network company (like Krowdis), if sponsor(s) want to proceed so (otherwise they may be moderated after being published). In yet another embodiment, the profile tab may display a comment mechanism that allows users to comment on other user's profiles and created commercials.

FIG. 5B shows one embodiment of what happens when clicking on the <<points/medals>> button. Most of the time when a user posts and gets some rewards from other users, he gets more points.

These points can be converted into presents, cash etc. when the user wants to. During some contests, users can also get some medals. For instance, during a contest if a user gets 50 rewards, $5 can be given to a charity (if it is in the rules) and the user gets a medal saying he succeeded doing that (that he can share).

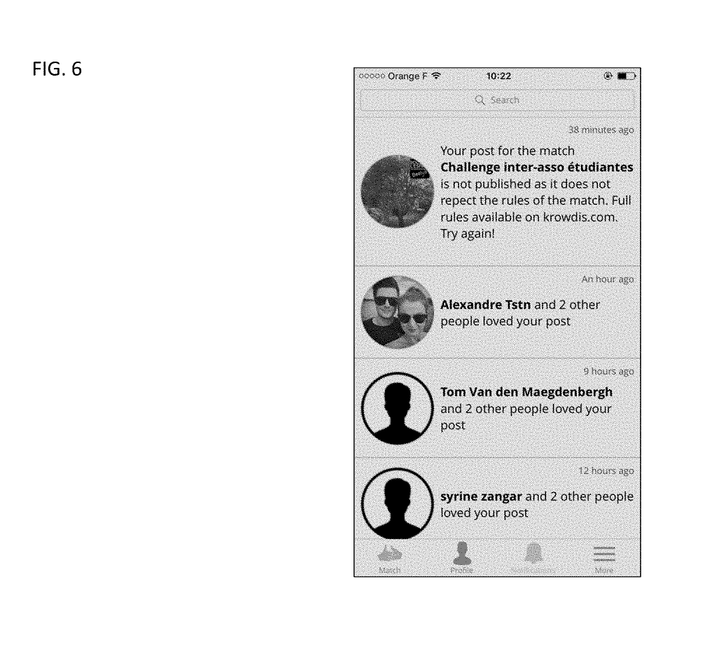

FIG. 6 illustrates one embodiment of the mobile device application notification tab. The notification tab option allows the third-party commercial network company to keep the user abreast to any changes in his account. For example, a user may be notified if the third-party commercial network company validates his submitted medium. Further, through the notification tab, a user is able to track the number of awards his medium receives.

While several embodiments of the instant platform have been illustrated by way of example, it is apparent that further embodiments could be developed within the spirit and scope of the instant invention. However, it is to be expressly understood that such modifications and adaptations are within the spirit and scope of the instant invention, as set forth in the following claims.

What is claimed:

1. A method for customizable advertising, the steps comprising:
collecting registration information from a user, the registration information including demographic, geographic and chronological information about the user;
creating a medium through a third-party commercial network company for a sponsored contest;
submitting the medium to the third-party commercial network company to participate in the sponsored contest;
receiving medium validation by the third-party;
submitting the medium to the sponsored contest;
sending the medium to the user's social media network platforms;
tracking and recording viewing of the medium;
collecting individual results, gathering them and calculating the winning team in live thanks to a simple algorithm (ponderation between the number of fans, the number of medium created, the number of shares, and the number of views and awards);
receiving at least one award option for the medium; and
compensating the user based on a high number of the at least one award option.

2. The method of claim 1, wherein the third-party commercial network company hosts the sponsored contests for an entity (and its sponsors) advertising.

3. The method of claim 1, wherein the sponsored contest is accessible through the user's mobile device.

4. The method of claim 1, wherein the created medium are limited to still pictures only.

5. The method of claim 1, wherein the created advertisements are limited to fixed-length video clips.

6. A method for soliciting the creation of mediums from users during contests to improve the digital experience of users during those events as well as the effectiveness of advertising for the entity/sponsors linked to the event, comprising the steps of:
displaying a contest offer from a first user for creating a new medium linked to the event aiming at illustrating it and/or the way the user is fan of it, wherein the contest offer specifies incentive to create the medium, as well as conditions for submitting it;
receiving submissions of created medium from one or more users;
accepting and/or rejecting one or more submitted created medium;
reviewing a recognition response of the submitted created medium;
declaring the submitted created medium winner for a group;
declaring a “group” that wins the contest and, terminating the contest.

7. The method of claim 6, wherein the success of the submitted created medium is based on the number of awards the submitted created medium receives in a given period of time.

8. The method of claim 6, wherein the duration of the competition is set by the first user for any period of time.

9. The method of claim 6, wherein the first user receives submissions of created medium from at least one user.

10. A system for providing mobile device event contests comprising:
a media server to generate incoming and outgoing data signals for delivery of media to mobile devices;
a subscriber system operative to enroll subscribers into the system and collect information including demographic, location, and other data from each subscriber and to permit subscribers to log into the system to modify existing data, add new data, and withdraw from the system;
a subscriber database, wherein the subscriber database stores all the collected information about each subscriber;
an event interface system operative to enroll subscribers into the system, and permit subscribers to participate in an event contest; and
an event database, wherein the event database stores all medium created by the subscriber.

11. The system of claim 10, further including a system to provide notifications to subscribers regarding mediums.

12. The system of claim 10, further including a system to provide awards to subscribers regarding their created mediums.
